(19) United States
(12) Patent Application Publication
(10) Pub. No.: US 2026/0184170 A1
(43) Pub. Date: Jul. 2, 2026

(54) METHODS FOR INCREASING VISIBILITY OF A FRONT VIEW OF A VEHICLE

(71) Applicant: Harman Becker Automotive Systems, Inc., Novi, MI (US)

(72) Inventor: Saubhagya Ranjan Das, Bangalore (IN)

(21) Appl. No.: 19/412,662

(22) Filed: Dec. 8, 2025

(30) Foreign Application Priority Data
Dec. 31, 2024 (IN) 202441105053

(51) Int. Cl. B60K 35/28; B60K 35/10; B60K 35/22; G06V 10/75; G06V 20/20; G06V 20/56

(52) U.S. Cl. CPC B60K 35/28; B60K 35/10; B60K 35/22; G06V 10/751; G06V 20/20; G06V 20/56; B60K 2360/148; B60K 2360/176; B60K 2360/177; B60K 2360/1868; B60K 2360/334; B60K 2360/785

(57) ABSTRACT

Systems and methods are provided herein for generating a video of a front view of a vehicle during low visibility conditions, such as when visibility is obstructed by elements of weather (e.g., rain, snow, fog, etc.), where the elements of weather are removed from the video in real time using a machine learning (ML) model. The video may be displayed without the rain, snow, or fog on a windshield of the vehicle. In this way, an operator of the vehicle may be provided a clear or enhanced view of a road in front of the vehicle even in poor weather conditions.

### CROSS REFERENCE TO RELATED APPLICATIONS

The present application claims priority to Indian Provisional Application No. 202441105053, entitled “METHODS FOR INCREASING VISIBILITY OF A FRONT VIEW OF A VEHICLE”, and filed on Dec. 31, 2024. The entire contents of the above-listed application are hereby incorporated by reference for all purposes.

### TECHNICAL FIELD

The disclosure relates to an in-vehicle augmented reality projector, as well as related operations.

### BACKGROUND

During low-visibility conditions such as darkness, heavy rain, snow, fog, etc., visibility through a vehicle windshield may be impaired, where an operator of a vehicle may not be able to clearly view a road the vehicle is traveling on and elements of an environment in front of the vehicle. Current solutions include using windshield wipers and/or exterior lighting, such as head lights or fog lights. However, the current solutions may not sufficiently provide a clearly visible road and environment.

### SUMMARY

In one embodiment, a system for a vehicle, the system comprising an augmented reality (AR) projector; and an in-vehicle computing system including a memory storing instructions executable to: when the vehicle is being operated under low-visibility conditions: capture video images of a front view of the vehicle in real time, via a camera of the vehicle; process the captured video images to create an enhanced view of the front view, using one or more artificial intelligence (AI) algorithms; render a portion of a windshield of the vehicle opaque; and project the enhanced view on the opaque portion of the windshield of the vehicle using the AR projector.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example partial view of a vehicle cabin;

FIG. 2 shows an example in-vehicle computing system;

FIG. 3 shows an example projection unit for displaying an augmented reality (AR) view on a windshield of a vehicle;

FIG. 4 is a flowchart illustrating an exemplary high-level method for displaying a front view of a vehicle captured by a camera on a windshield of the vehicle using an AR system;

FIG. 5 is a flowchart illustrating an exemplary method for adjusting a size of the front view of the vehicle on the windshield;

FIG. 6 is a flowchart illustrating an exemplary method for terminating the display of the front view of the vehicle on the windshield in response to changes in the environment;

FIG. 7 shows a first series of images depicting a first display of the front view of the vehicle on the windshield of the vehicle using the AR system; and

FIG. 8 shows a second series of images depicting a second display of the front view of the vehicle on the windshield of the vehicle using the AR system.

### DETAILED DESCRIPTION

Systems and methods are provided herein for generating an enhanced view of an external, front environment of a vehicle through a windshield of the vehicle using one or more cameras of the vehicle, and displaying the enhanced view on the windshield. In various embodiments, the enhanced view may be displayed on the windshield using an augmented reality (AR) projection device. The enhanced view may be a clearer view of the front environment than an actual view through the windshield. For example, in low visibility conditions such as at night or during adverse weather, darkness, rain, fog, snow, etc. may reduce a visibility of the actual view through the windshield. The enhanced view may include video images of the actual view with increased lighting and/or with the rain, fog, or snow reduced or removed. In various embodiments, the enhanced view may be generated by an artificial intelligence (AI) algorithm installed at the vehicle. For example, the AI algorithm may include a machine learning (ML) model that takes a first stream of images acquired by the one or more cameras in real time as input, and outputs a second stream of images with the rain, fog, or snow reduced or removed, and/or a lighting of the images increased.

To display the enhanced view to the operator, the inventors herein describe systems and methods for displaying the second stream of images (e.g., the enhanced view) on the windshield, in a manner that safe and convenient for the operator. For example, the enhanced view may be displayed based on a request by the operator. In various examples, the algorithm for generating the enhanced view may be applied to the first stream of images when low visibility conditions are detected by sensors of the vehicle. The visibility through the windshield and a quality of the enhanced view (e.g., the second stream of images) may be assessed. If the visibility decreases below a first threshold, and/or the quality exceeds a threshold quality, the display of the enhanced view on the windshield may be enabled, and the operator may be notified of the availability of a display of the enhanced view on the windshield.

If the operator requests the enhanced view (e.g., in response to the notification), the second stream of images may be projected or otherwise projected onto a portion of the windshield via a projector positioned in a cabin of the vehicle, for example, on the dashboard of the vehicle. The portion may occupy a small percentage of the total area of the windshield, and may be unobtrusively positioned on the windshield. To project the second stream of images on the portion, in various embodiments, the portion of the windshield may be tinted using electrical tinting technology such that the portion is opaque. In one example, the windshield may be constructed with glass having liquid crystals embedded therein. The liquid crystals may be electrically connected to a battery of the vehicle. When a voltage is applied to the liquid crystals, a tinted color may be produced that obstructs light passing through the windshield. The second stream of images may then be displayed on the tinted portion of the windshield. In other examples, a film may be integrated into the windshield, and the second stream of images may be projected onto the film.

The operator may accept the enhanced view, or may request that the display of the enhanced view on the portion of the windshield be terminated. In various examples, the request may be a verbal request that is captured by a microphone of the vehicle and processed by a controller of the vehicle. Additionally or alternatively, the operator may request that the display of the enhanced view be expanded to occupy a greater amount of area of the windshield. In some examples, the display of the enhanced view may be computationally adjusted to fit a size of the windshield.

Further, the quality of the second stream of images may be monitored and continuously assessed. In circumstances where sudden changes occur in the quality of the second stream of images, the electronic tinting of the portion on which the enhanced view is projected may be reduced or terminated. When the tinting is reduced or terminated, the projected enhanced view may not be visible on the windshield, or may become transparent, such that the actual view of the front of the vehicle is visible through the windshield. As an example, if the vehicle enters a tunnel, a sudden change in lighting conditions may cause a momentary distortion of the second stream of images, as the camera adjusts to the change in lighting conditions. For example, the second stream of images may become darker, or lighter. Additionally or alternatively, a different AI algorithm may be applied to increase the lighting of the second stream of images. During the momentary distortion and/or transition between AI algorithms, the electronic tinting of the portion of the windshield may be suspended, causing the display of the enhanced view on the windshield to disappear. After the camera adjusts to the new lighting conditions and the quality of the second stream of images increases above a threshold quality, the portion of the windshield may be electronically tinted again, and the display of the enhanced view may be reinstated on the windshield.

In this way, the operator may have a clearer view of a front environment of the vehicle during adverse weather such as heavy rain, snow, or fog, including a road that the vehicle is travelling on, traffic concurrently travelling on the road or other roads, elements of infrastructure or nature on sides of the road, etc. As a result, a safety and a comfort of the operator may be increased.

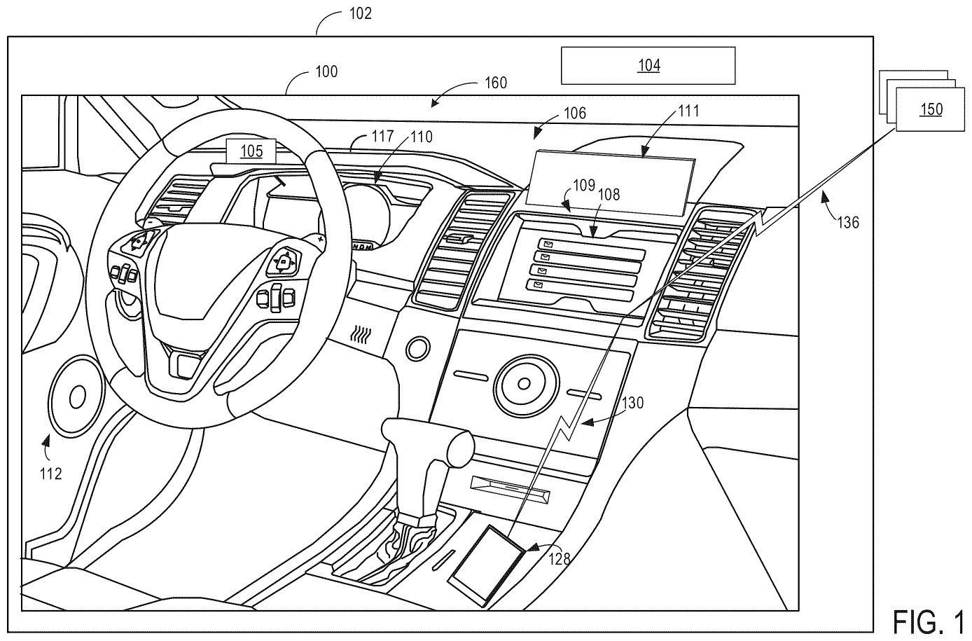

Turning to FIG. 1, an interior of a cabin 100 of a vehicle 102 in which an operator and/or one or more passengers may be seated is shown. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a human operator (also referred to as the user) of vehicle 102. For example, instrument panel 106 may include a touch screen 108 of an in-vehicle computing system 109 (e.g., an infotainment system), an audio system control panel, and an instrument cluster 110. Touch screen 108 may receive user input to the in-vehicle computing system 109 for controlling audio output, visual display output, user preferences, control parameter selection, etc. While the example system shown in FIG. 1 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128. The audio system of the vehicle may include an amplifier (not shown) coupled to plurality of loudspeakers (not shown). In some embodiments, one or more hardware elements of in-vehicle computing system 109, such as touch screen 108, a display screen 111, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system 109 may be modular and may be installed in multiple locations of the vehicle.

The vehicle may include one or more sensors for monitoring the vehicle, the user, and/or the environment. For example, sensors may be positioned in a powertrain compartment, on an external surface of the vehicle, and/or in other suitable locations for providing information regarding the operation of the vehicle, ambient conditions of the vehicle, a user of the vehicle, etc. Information regarding ambient conditions of the vehicle may be received from sensors external to/separate from the vehicle (that is, not part of the vehicle system), such as sensors coupled to external devices 150 and/or mobile device 128. For example, the sensors may detect a low visibility condition, such as darkness and/or an adverse weather condition, such as snow, ice, fog, etc. Based on data captured by the sensors, a controller of the vehicle may assess a degree or amount of the darkness and/or adverse weather.

The vehicle may include one or more cameras for monitoring the vehicle surroundings, traffic information, and/or the environment, which may also detect the adverse weather conditions. For example, cameras may be positioned on the front, the sides, the rear, the top, and/or any other position on the vehicle. Image information captured by the one or more cameras may be displayed on the device displays described herein. For example, when the vehicle is operating in adverse weather including visual weather elements that may obscure a view of the operator, such as heavy rain, snow, or fog, a video feed from one or more front cameras may be used to assess the degree or amount of the adverse weather and/or a visibility through the heavy rain, snow, or fog.

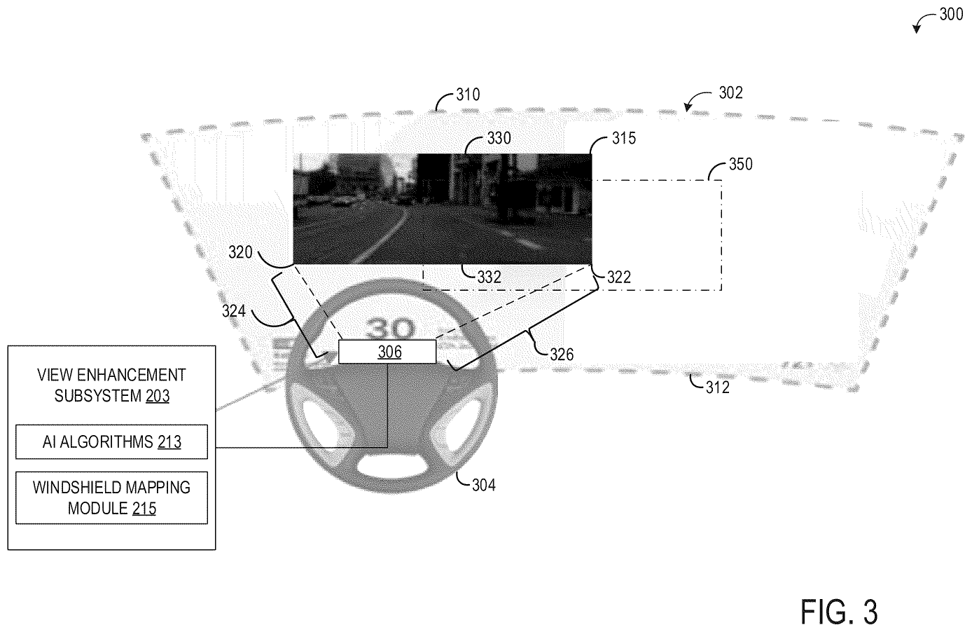

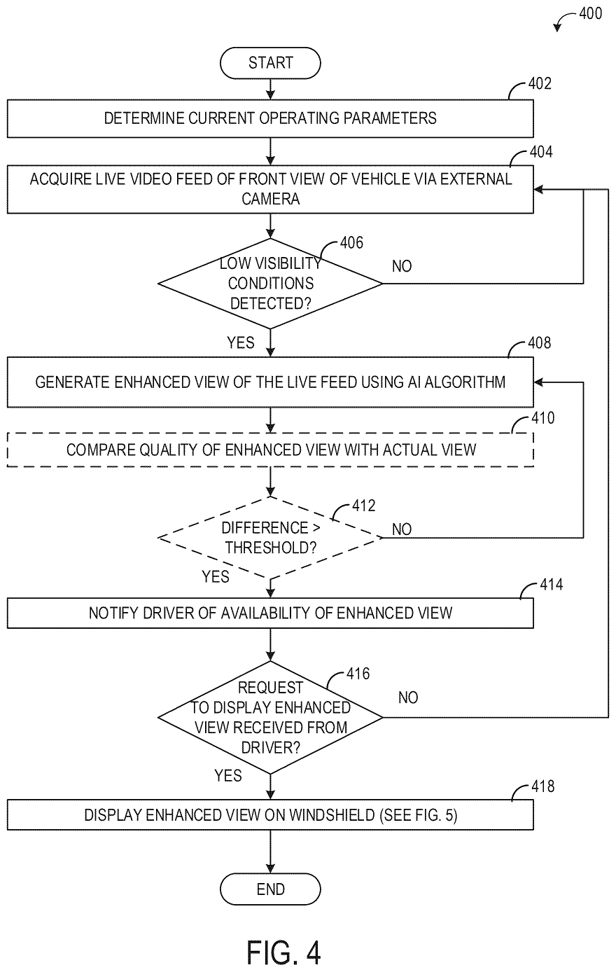

Additionally, in response to the visibility decreasing below a threshold, the feed from the one or more front cameras may be enhanced (e.g., to show a clearer view of the front of the vehicle) using one or more artificial intelligence (AI) algorithms, and the enhanced feed may be displayed on a windshield 160 of vehicle 102, as described in greater detail below. For such purpose, cabin 100 may include a projector 105, which may project the feed on the windshield, in accordance with a method such as method 400 of FIG. 4. In the depicted embodiment, projector 105 is positioned on a dashboard 117 of cabin 100. In other embodiments, projector 105 may be positioned at a different location of cabin 100, such as in a ceiling, chair, door, etc. of cabin 100. Projector 105 is described in greater detail below in reference to FIG. 3.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct, Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/operators for operating the physical devices in accordance with other devices in the mobile device. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108. As described herein, the communication link may be limited in some locations, referred to as black spots.

In-vehicle computing system 109 may analyze the input received from external devices 150, mobile device 128, and/or other input sources and select settings for various in-vehicle systems (such as the audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

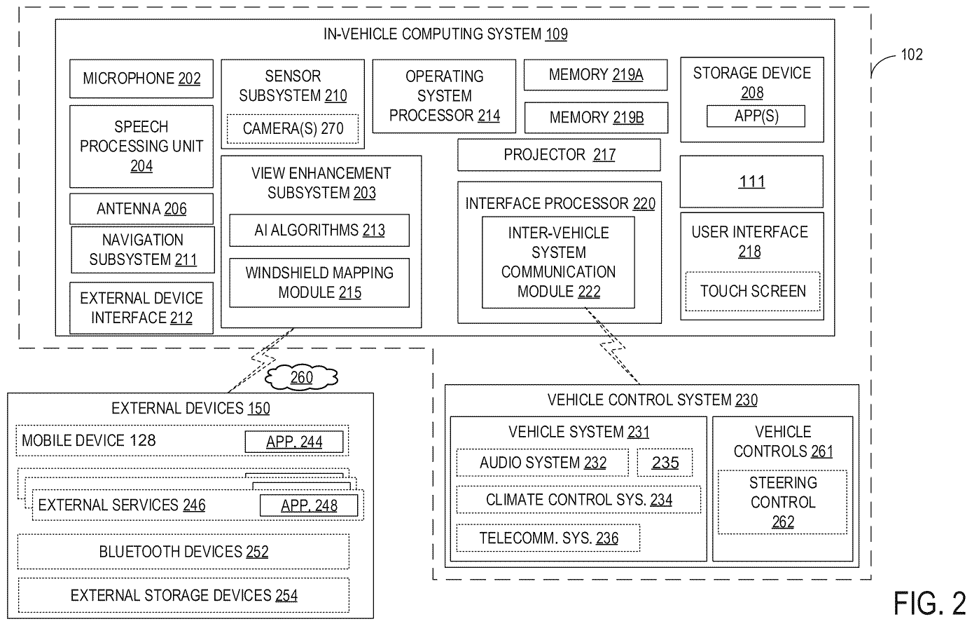

FIG. 2 shows a block diagram of an in-vehicle computing system 109 configured and/or integrated inside vehicle 102. In-vehicle computing system 109 may perform one or more of the methods described herein in some embodiments. In some examples, the in-vehicle computing system 109 may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 102 in order to enhance an in-vehicle experience for an operator and/or a passenger.

In-vehicle computing system 109 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine CAN bus through which engine related information may be communicated, a climate control CAN bus through which climate control related information may be communicated, and a multimedia data network through which multimedia data is communicated between multimedia components in the vehicle). For example, the in-vehicle computing system 109 may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 109 to store data such as instructions executable by processors 214 and 220 in non-volatile form. The storage device 208 may store application data, including prerecorded sounds, to enable the in-vehicle computing system 109 to run an application for connecting to a cloud-based server and/or collecting information for transmission to the cloud-based server. The application may retrieve information gathered by vehicle systems/sensors, input devices (e.g., user interface 218), data stored in volatile 219A or non-volatile storage device (e.g., memory) 219B, devices in communication with the in-vehicle computing system (e.g., a mobile device connected via a Bluetooth link), etc. In-vehicle computing system 109 may further include a volatile memory 219A. Volatile memory 219A may be random access memory (RAM). Non-transitory storage devices, such as non-volatile storage device 208 and/or non-volatile memory 219B, may store instructions and/or code that, when executed by a processor (e.g., operating system processor 214 and/or interface processor 220), controls the in-vehicle computing system 109 to perform one or more of the actions described in the disclosure.

A microphone 202 may be included in the in-vehicle computing system 109 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 109 may also be able to receive voice commands and sample ambient vehicle noise using a microphone included in an audio system 232 of the vehicle. In one example, microphone 202 may be used to receive voice commands from an operator of the vehicle for displaying video content on a windshield (e.g., windshield 160) of the vehicle. The video content may include enhanced video images acquired via a camera of the vehicle and altered via one or more AI algorithms. For example, the enhanced video images may include an enhanced (e.g., clearer) view of the front of the vehicle, as described in greater detail in reference to FIGS. 3-8.

One or more additional sensors may be included in a sensor subsystem 210 of the in-vehicle computing system 109. For example, the sensor subsystem 210 may include a camera 270, such as a front view camera for assisting a user in operating the vehicle and/or a cabin camera for identifying a user (e.g., using facial recognition and/or user gestures). In-vehicle computing system 109 may include a view enhancement subsystem 203, which may communicate with sensor subsystem 210. View enhancement subsystem 203 may include one or more AI algorithms 213 configured to enhance images acquired with a camera 270, for display to the operator. With arrival of augmented reality (AR) in autonomous vehicles and automotive world, there are opportunities to implement various scenarios without distracting operator attention. AR can be used to display content to the operator, including content generated by the camera 270. In particular, embodiments are disclosed herein to project, via AR, video data from an external environment of the vehicle to the operator on a windshield of the vehicle (e.g., windshield 160). The projection may be performed by a projector 217 of in-vehicle computing system 109. The windshield may be tinted, and video images captured by a front camera of the vehicle (e.g., camera 270) may be enhanced and projected on the windshield via projector 217. For example, during adverse weather, the video images may be enhanced by removing rain, snow, or fog from the video images captured by the front camera, using view enhancement subsystem 203, in accordance with a method such as method 400 of FIG. 4. One of the main aspects of this method is to receive data from a vehicle, analyze, and send augmented images back to the vehicle for projection on the display. In AR projections, the most commonly used method is usage of projection display with touch screen capabilities. One advantageous feature of this disclosure is that a method is employed where the windshield is used as a plane to project augmented images. Because the windshield may not be rectangular and may be curved, view enhancement subsystem 203 may include a windshield mapping module 215, which may calculate and perform adjustments to the augmented images such that the images do not appear distorted when projected on the windshield. The display of an enhanced front view of the vehicle on the windshield is described in greater detail below.

Sensor subsystem 210 of in-vehicle computing system 109 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 109 may generate and/or receive navigation information such as location information (e.g., via a GPS sensor and/or other sensors from sensor subsystem 210), route guidance, traffic information, point-of-interest (POI) identification, and/or provide other navigational services for the operator.

External device interface 212 of in-vehicle computing system 109 may be coupleable to and/or communicate with one or more external devices 150 located external to vehicle 102. While the external devices are illustrated as being located external to vehicle 102, it is to be understood that they may be temporarily housed in vehicle 102, such as when the user is operating the external devices while operating vehicle 102. In other words, the external devices 150 are not integral to vehicle 102. The external devices 150 may include a mobile device 128 (e.g., connected via a Bluetooth, NFC, WIFI direct, 4G LTE, 5G connection, or other wireless connection) or an alternate Bluetooth-enabled device 252. Mobile device 128 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. External devices 150 may communicate with in-vehicle computing system 109 either wirelessly or via connectors without departing from the scope of this disclosure. For example, external devices 150 may communicate with in-vehicle computing system 109 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the operator. For example, the external device interface 212 may enable phone calls to be established and/or text messages (e.g., SMS, MMS, etc.) to be sent (e.g., via a cellular communications network) to a mobile device associated with a contact of the operator. The external device interface 212 may additionally or alternatively provide a wireless communication interface to enable the in-vehicle computing system to synchronize data with one or more devices in the vehicle (e.g., the operator's mobile device) via WIFI direct.

One or more applications 248 may be operable on external services 246. As an example, external services applications 248 may be operated to aggregate and/or analyze data from multiple data sources. For example, external services applications 248 may aggregate data from the in-vehicle computing system (e.g., sensor data, log files, user input, etc.), data from an internet query (e.g., weather data, POI data), etc. The collected data may be transmitted to another device and/or analyzed by the application to determine a context of the operator, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers 235. Vehicle audio system 232 may be passive or active such as by including a power amplifier. In some examples, in-vehicle computing system 109 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 102. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in an operator or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers 235 of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. The control signals may also control audio output when notifying an operator of the vehicle that an AR view of the front of the vehicle is available for display, as described in greater detail below. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 109, such as via communication module 222. The control elements of the vehicle control system may be physically and permanently positioned on and/or in the vehicle for receiving user input. In addition to receiving control instructions from in-vehicle computing system 109, vehicle control system 230 may also receive input from one or more external devices 150 operated by the user, such as from mobile device 128. This allows aspects of vehicle systems 231 and vehicle controls 261 to be controlled based on user input received from the external devices 150.

In-vehicle computing system 109 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via FR such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 150 (such as to mobile device 128) via external device interface 212.

One or more elements of the in-vehicle computing system 109 may be controlled by a user via user interface 218. User interface 218 may include a graphical user interface presented on a touch screen, such as touch screen 108 of FIG. 1, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 109 and mobile device 128 via user interface 218. In addition to receiving a user's vehicle setting preferences on user interface 218, vehicle settings selected by in-vehicle control system may be displayed to a user on user interface 218. Notifications and other messages (e.g., received messages), (e.g., notifications of the availability of an enhanced view of a front environment of the vehicle captured by camera of the vehicle for projection on a windshield of the vehicle), as well as navigational assistance, may be displayed to the user on a display of the user interface. User preferences/information and/or responses to presented messages may be performed via user input to the user interface.

In some examples, vehicle 102 may operate in one or more autonomous modes where some or all vehicle operations (e.g., acceleration, braking, steering) are controlled automatically without operator input. To facilitate autonomous or semi-autonomous operation, the vehicle may utilize output from the various sensors described herein (e.g., a radar sensor, a machine vision camera) to identify and track vehicles, pedestrians, bicyclists, rough roads, potholes, and other objects and report those objects to an autonomous control module. The autonomous control module may be part of the vehicle control system 230.

For example, the radar sensor may communicate with the autonomous control module over a vehicle data network such as the CAN bus, Flexray, or Ethernet. The machine vision camera may also identify lane markings and report the curvature of the road ahead to the autonomous control module. It should be understood that the radar sensor and machine vision camera here are exemplary to represent any number of possible sensors. In practice, a vehicle may have many more sensors than the two discussed herein. For example, vehicles may utilize multiple radar sensors and cameras which face in different directions, have different ranges, and have different fields of view.

The autonomous control module may process information received from the vehicle sensors (e.g., the radar sensor and the machine vision camera) and calculate vehicle control actions in response thereto. The autonomous control module may communicate with the vehicle's brakes to initiate braking if the sensor data indicates the presence of an object ahead and in the path of the host vehicle. The autonomous control module may also communicate with the vehicle's steering system to apply torque to the steering and prevent the vehicle from drifting out of the lane or to steer around an object in the path of the vehicle.

FIG. 3 shows an example augmented reality (AR) configuration 300 where an AR display of video images 315 of a front view of a vehicle, such as vehicle 102 of FIG. 1, may be displayed on a windshield 302. Video images 315 may be projected on windshield 302 via an AR projector 306 (e.g., projector 105, 217) mounted on a dashboard of the vehicle (e.g., dashboard 117 of FIG. 1). In the depicted example, AR projector 306 is mounted behind a steering wheel 304 of the vehicle. In other examples, AR projector 306 may be mounted at a different location on the dashboard or in a cabin of the vehicle. The AR projector 306 may receive video images 315 from a view enhancement subsystem of an in-vehicle computing system, such as view enhancement subsystem 203 of in-vehicle computing system 109. Video images 315 may be captured by a camera of the vehicle (e.g., a camera 270), such as a front-end camera, and processed by the view enhancement subsystem 203 to enhance video images 315. Enhancing video images 315 may include removing visual weather elements from the video images, such as rain, snow, fog, dust, smoke, etc., using one or more AI algorithms known in the art (e.g., AI algorithms 213). Enhancing video images 315 may also include increasing an amount of lighting of the video images, and/or converting low-light (e.g., dark images taken at night, in a tunnel, etc.) to images with a higher visibility or lighting contrast using the one or more AI algorithms.

A size of video images 315 on windshield 302 may vary, depending on a configuration of view enhancement subsystem 203 and/or an operator request/selection. In various embodiments, video images 315 may first be displayed at an initial size when first projected on windshield 302. The initial size may occupy a small area of windshield 302 (e.g., less than 20% of a total area of windshield 302, for example). The size of video images 315 may be increased by the operator. For example, the size of video images 315 may be adjusted according to voice commands issued by the operator. The operator may request that the size of video images 315 be increased, and in response, the dimensions of video images may be expanded such that video images 315 occupy a greater amount of the total area of windshield 302. The size of video images 315 may be increased in pre-configured steps, up to a maximum size. In some embodiments, when video images 315 are projected at the maximum size, video images 315 may occupy approximately the total area of windshield 302. In other words, at the maximum size, video images 315 may be fit to windshield 302, such that an actual front view of the vehicle through windshield 302 may be obscured by video images 315. The operator may also decrease the size of video images 315 by the pre-configured steps, using voice commands or in a different manner. In this way, the operator may adjust the size of video images 315 on windshield 302 to a desired size.

Additionally, in some embodiments, the operator may adjust a position of video images 315 on windshield 302. For example, in FIG. 3, video images 315 are projected on windshield 302 at a first position, towards a left size of windshield 302 and approximately in front of the operator. The operator may wish to move video images 315 to a second position 350, where second position 350 is centered on windshield 302. To move video images 315 from the first position to second position 350, the operator may issue voice commands, such as “move the enhanced view to the right/left/up/down”. In response to the voice commands, view enhancement subsystem 203 may adjust the position of video images 315 on windshield 302 in the commanded direction by preconfigured steps. In this way, the operator may position video images 315 at a desired location on windshield 302.

Windshield 302 may not be rectangular. For example, windshield 302 may have a curved upper edge 310 at an intersection of windshield 302 with a roof of the vehicle, and/or a curved lower edge 312 at an intersection of windshield 302 with a dashboard of the vehicle. Additionally, windshield 302 may not be perpendicular to an alignment or an aperture of AR projector 306. As a result, when video images 315 are displayed on windshield 302, video images 315 may appear distorted.

For example, in FIG. 3 a lower left corner 320 of video images 315 may be a first distance 324 from AR projector 306, and a lower right corner 322 of video images 315 may be a second, greater distance 326 from AR projector 306. Additionally, windshield 302 may be slanted, such that a top edge 330 of video images 315 may be closer to AR projector 306 than a bottom edge 332 of video images 315. As a result, video images 315 may appear skewed when displayed on windshield 302.

To address this problem, video images 315 may be processed, in real time, prior to being projected on windshield 302, to adjust boundaries and proportions of video images 315 such that when the processed video images 315 are projected on windshield 302 by AR projector 306, the processed video images 315 provide a realistic representation of the front view of the vehicle captured by the front end camera. The processing may be performed in accordance with programming instructions stored in windshield mapping module 215 and executed by a processor of a computing system of the vehicle (e.g., in-vehicle computing system 109). The processing may comprise determining a first bounding box of video images 315 on a first plane perpendicular to a direction of projection of AR projector 306, in accordance with commands issued by the operator. The first bounding box may be defined by coordinates of the first plane. The first bounding box may then be mapped to a second bounding box on windshield 302, based on a predefined geometric model. Pixels of video images 315 may then be adjusted in accordance with the predefined geometric model to generate an accurate representation of the front view of the vehicle on windshield 302. The generation of video images 315 on windshield 302 may be performed in accordance with a method 400 of FIG. 4.

Turning now to FIG. 4, a flowchart illustrates a method 400 for displaying an AR display of a front view of a vehicle captured by a camera of the vehicle on a windshield of the vehicle, where the AR display of the front view may include an enhanced view generated by applying one or more AI algorithms to enhance video captured by the camera. The enhanced view may be a clearer view of an environment in front of the vehicle. In particular, the enhanced view may increase a lighting of the video and/or remove or reduce visual weather elements such as rain, snow, fog, dust, smoke, or other types of particles and/or adverse weather from the video captured by the camera. By viewing the enhanced view on the windshield, a visibility of an operator of the vehicle may be increased, thereby increasing a safety and comfort of the operator. Method 400 and the other methods described herein may be performed using the components of in-vehicle computing system 109. Method 400 and the other methods may be carried out according to instructions stored in non-transitory memory of an in-vehicle computing device, such as in-vehicle computing system 109 or IVI controller 404, and executed by a processor of the in-vehicle computing device.

At 402, current operating parameters are determined. The current operating parameters may include current vehicle operating parameters, such as vehicle speed, vehicle assistance mode (e.g., autonomous operation, semi-autonomous operation, or full operator control), current in-vehicle infotainment settings, current route, and so forth. The current operating parameters may be determined based at least in part on the sensors and/or communication modules described above with respect to FIG. 2.

At 404, method 400 includes acquiring a live video feed of a front view of the vehicle, via a camera (e.g., camera 270). The camera may be mounted on a front end of the vehicle, or roof of the vehicle, or at a different location where a front view of the vehicle may be acquired. The live feed may be transmitted from the camera to a view enhancement subsystem of the vehicle (e.g., view enhancement subsystem 203 of FIG. 2), where images (e.g., video images 315 of FIG. 3) may be processed. The processing may include determining, from the images, whether low-visibility conditions exist, where a visibility of elements of an environment in the front of the vehicle is below a threshold visibility. The low-visibility conditions may be detected when adverse weather such as rain, fog, snow, dust, etc., is detected in the images, above a threshold amount. For example, the rain, fog, snow, dust, etc., may be detected in the images by a machine learning (ML) model (e.g., an artificial neural network model), using techniques known in the art. Other sensors and systems of the vehicle may additionally be used to detect the adverse weather and/or low visibility conditions, such as temperature sensors, use of windshield wipers and/or fog lights, etc.

At 406, method 400 includes determining whether the low visibility conditions are detected. If the low visibility conditions are not detected, method 400 proceeds back to 404, where method 400 includes continuing to acquire the live video feed of the front view of the vehicle. Alternatively, if the low visibility conditions are detected at 406, method 400 proceeds to 408.

At 408, method 400 includes generating an enhanced view of the live feed using one or more AI algorithms (AI algorithms 213). The enhanced view may be a view where visual weather elements of the adverse weather are reduced or removed from the live feed. The visual weather elements may include rain drops or streaks of rain on a lens of the camera, snowflakes, particles of dust, etc. The visual weather elements may include fog and/or particles of water, snow, smoke, dust, etc. that are too small to see individually, but which collectively obscure the front view and/or alter an appearance of elements of an environment within the front view of the vehicle. The AI algorithms may take the live feed of video images as input, and may output an enhanced live feed in real time, where the enhanced live feed shows a clearer view of the front of the vehicle. The clearer view of the vehicle may not show, or may show a lesser amount of the adverse weather and/or particles of water, snow, smoke, dust, etc. In other examples, the enhanced view may include increased lighting. For example, a live feed of a nighttime view of a road may be converted into an enhanced live feed of images similar to a daytime view of the road, using techniques known in the art.

In various embodiments, the AI algorithms may be generated by a third party, such as an original equipment manufacturer (OEM) of the vehicle. The AI algorithms may be installed in a memory of the vehicle accessible to the in-vehicle computing device by the third party at a time of manufacture of the vehicle, or installed at a later time. The AI algorithms may include various different AI algorithms known in the art. For example, a first algorithm may be selected to remove rain from the live feed; a second algorithm may be selected to remove snow from the live feed; a third algorithm may be selected to remove fog from the live feed; a fourth algorithm may increase a lighting of the live feed; and so on. The AI algorithms may be applied to the live feed in sequence, in some examples.

At 410, in some examples, method 400 may include comparing a quality of the enhanced view of the live feed of images with the actual view, meaning, the live feed of images from the camera prior to enhancement using the AI algorithms. For example, a first contrast of the enhanced view may be compared with a second contrast of the actual view, or a comparative quality assessment of the enhanced view and the actual view may be performed by one or more models or algorithms. For example, an edge detection algorithm may be applied to determine whether fine details in the environment in front of the vehicle are more clearly visible in the enhanced view than the actual view. At 412, if the quality of the enhanced view is greater than a quality of the actual view by a predefined threshold amount, then method 400 proceeds to 414. If the quality of the enhanced view is not greater than the quality of the actual view by the threshold amount, method 400 may proceed back to 408, where the controller may continue to generate the enhanced view.

It should be appreciated that adverse weather can change dramatically and/or quickly, where at a first time, the enhanced view may be of a higher quality than the actual view, and at a second, later time, the enhanced view may not be of a higher quality than the actual view, and may not offer increased visibility over the actual view. In such cases, the enhanced view may not be displayed to the operator. In other cases, steps 410 and 412 may not be performed, and the enhanced view may be made available to the operator without assessing the quality of the enhanced view. In such cases, the operator may make a final decision whether or not to display the enhanced view.

At 414, method 400 includes notifying the operator of the availability of the enhanced view. The availability of the enhanced view may be indicated to the operator in various ways. For example, the availability of the enhanced view may be indicated via text or a visual element on a display screen of the vehicle (e.g., display screen 111 or touch screen 108 of FIG. 1). Additionally or alternatively, the availability of the enhanced view may be indicated via an audio recording played back via a speaker of the vehicle, which may include verbal notification, or a sound, tone, etc. In other examples, the availability of the enhanced view may be indicated in a different manner.

At 416, method 400 includes determining whether a request is received from the operator to display the enhanced view on the vehicle windshield. In some examples, the operator may enter input via a user interface (e.g., touch screen 108 and/or user interface 218) of the vehicle, requesting that the enhanced view be displayed on the windshield. In other examples, the user may issue a voice command to display the enhanced view on the windshield, which may be captured by a microphone of the vehicle.

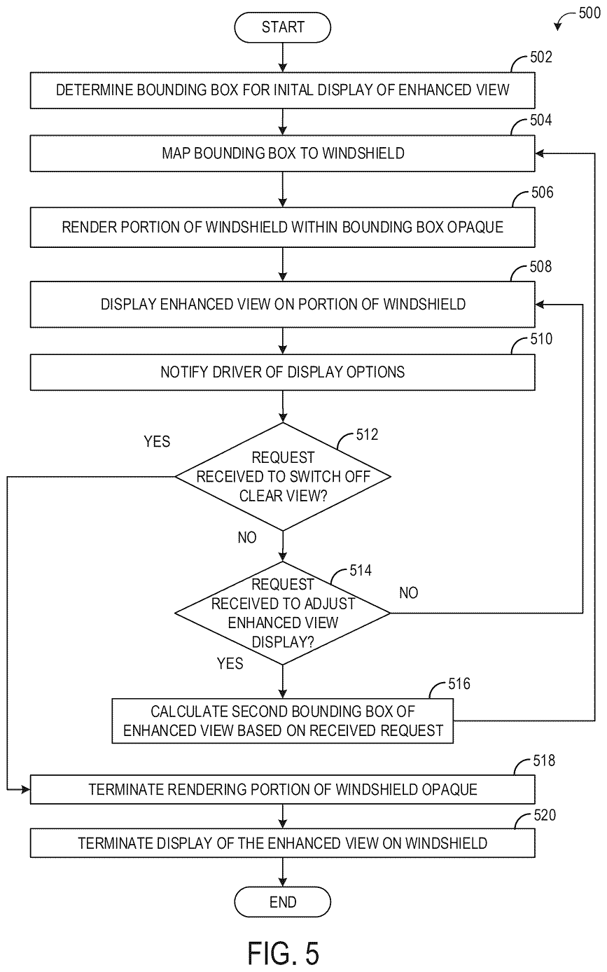

If no request to display the enhanced view is received from the operator at 416, method 400 proceeds back to 404, and method 400 continues acquiring the live video feed and generating the enhanced view. If the request to display the enhanced view is received from the operator, method 400 proceeds to 418. At 418, method 400 includes displaying the enhanced view on the windshield, and method 400 ends. The display of the enhanced view on the windshield is described below in method 500 of FIG. 5.

Turning to FIG. 5, a method 500 is shown for displaying an enhanced view of a front of a vehicle on a windshield of the vehicle, where the enhanced view may be generated as described in reference to FIGS. 3 and 4. The enhanced view may include video images acquired via a front end camera of the vehicle, that are altered by one or more AI algorithms of a view enhancement subsystem (view enhancement subsystem 203) of a vehicle computing system. The one or more AI algorithms may remove visual weather elements of the video images that obscure a front view of an environment of the vehicle, and/or increase a lighting of the environment when the video images are dark. Method 500 may be performed as part of method 400. In some embodiments, the steps of method 500 may be performed in a different order, or one or more steps of method 500 may be omitted.

Method 500 starts at 502, where method 500 includes determining a first bounding box for an initial display of the enhanced view on the windshield. The first bounding box may define a size and position of the enhanced view on the windshield. The first bounding box for the initial display may be predefined and retrieved from in a configuration file or lookup table of the view enhancement subsystem. In some examples, the size of the first bounding box may be configured by the operator. The first bounding box may have a first set of dimensions and a first size, where the first size may correspond to a portion of a total area of the windshield, as described in FIG. 3.

In various embodiments, displaying the enhanced view on the windshield within the bounding box includes projecting the enhanced view on the windshield using an AR projector of the vehicle (e.g., AR projector 306). The bounding box may be defined by coordinates of a first, virtual plane perpendicular to a direction of projection of the AR projector and at a fixed distance from an aperture of an AR projector used to display the enhanced view. The coordinates may be used to position the enhanced view at a location on the windshield.

It should be appreciated that while method 500 is described herein as projecting the enhanced view on the windshield, in other embodiments, a different technology may be used to display the enhanced view on the windshield.

At 504, method 500 includes mapping the initial display of the enhanced view to a surface of the windshield. Mapping the initial display of the enhanced view to the surface of the windshield may include mapping the first bounding box to a projection bounding box on a second plane defined by the surface of the windshield. That is, as explained in relation to FIG. 3, because the windshield may not be perpendicular to the projector, nor flat and rectangular, the enhanced view generated by the one or more AI algorithms may be adjusted to accurately represent the environment in front of the vehicle when the enhanced view is projected on the surface of the windshield. In various embodiments, the mapping from the first bounding box to the projection bounding box may be performed by adjusting a pixel-display of the enhanced view on the first, virtual plane to the second plane using a function calculated based on the coordinates of the first bounding box and a predefined geometric model. In some examples, pixel-to-pixel mappings may be stored in a memory of the view enhancement subsystem for a plurality of permitted bounding boxes, and a suitable pixel-to-pixel mapping may be selected by the view enhancement system based on a bounding box selection made by the operator.

At 506, method 500 includes rendering a portion of the windshield on which the enhanced view is to be displayed opaque, where the portion is defined by the mapping of the (first or a subsequent) bounding box to the windshield. That is, the mapping performed at step 504 may determine exact coordinates on the windshield where the enhanced view will be projected, and an area of the windshield within the coordinates may be rendered opaque. When the portion is opaque, the operator may not be able to see through the portion of the windshield.

In one example, the portion may be rendered opaque by electronically tinting the portion of the windshield. The windshield may be constructed with glass having liquid crystals embedded therein. The liquid crystals may be electrically connected to a battery of the vehicle. When a voltage is applied to the liquid crystals, a tinted color may be produced that obstructs light passing through the windshield. In other examples, the windshield may include a thin film electroluminescent display, and the second stream of images may be displayed on the windshield using via electroluminescent display, using techniques known in the art. In still other examples, the portion may be rendered opaque in a different manner.

At 508, method 500 includes displaying the mapped display of the enhanced view on the portion of the windshield. The mapped display may be projected on the (opaque) portion using the AR projector. When the mapped display of the enhanced view is projected on the opaque portion, the enhanced view (e.g., the clearer view of the external environment in front of the vehicle) may be visible to the operator. The operator may operate and navigate the vehicle based on the enhanced view, in addition to or rather than relying on an actual view of the external environment in front of the vehicle visible through the windshield.

At 510, method 500 includes notifying the operator of various options for displaying the enhanced view. For example, the operator may increase the size of the enhanced view to occupy a greater area of the windshield, decrease the size of the enhanced view to occupy a smaller area of the windshield, and/or adjust a position of the enhanced view on the windshield. In some examples, the enhanced view may be configured to be projected on approximately an entire area of the windshield. The options for adjusting the display of the enhanced view may be indicated on a display screen of the vehicle.

At 512, method 500 includes determining whether a request is received from the operator to switch off the enhanced view. If at 512 the request to switch off the enhanced view is not received from the operator, method 500 proceeds to 514. At 514, method 500 includes determining whether a request is received from the operator to adjust the position or size of the enhanced view on the windshield, using the options indicated to the operator at 510.

If at 514 the request to adjust the position or size of the enhanced view on the windshield is not received from the operator, method 500 proceeds to back to 508, and method 500 includes continuing to project the enhanced view on the opaque portion of the windshield. Alternatively, if at 514 a request to adjust the position or size of the enhanced view on the windshield is received from the operator, method 500 proceeds to 516.

At 516, method 500 includes calculating a second bounding box of the enhanced view on the first virtual plane perpendicular to the AR projector, in accordance with the operator's request. For example, the operator may issue a verbal command to “expand enhanced view”. The verbal command may be captured via a microphone of the vehicle. In response to detecting the verbal command, the view enhancement system may retrieve, from a lookup table stored in a memory of the view enhancement system, coordinates of the second bounding box on the first virtual plane. The coordinates of the second bounding box may correspond to a predefined step increase of the size of the enhanced view. Alternatively, the operator may issue a verbal command to “decrease enhanced view”, and in response, the view enhancement system may retrieve from the lookup table coordinates of the second bounding box corresponding to a predefined step decrease of the size of the enhanced view.

Method 500 then proceeds back to 504. At 504, method 500 includes mapping the second bounding box to a corresponding projection bounding box on the second plane aligned with the windshield. As described above, the mapping may be achieved by applying a function retrieved from the memory based on the second bounding box, in accordance with the geometric model. Method 500 then continues as described above: an updated portion of the windshield corresponding to the updated projection bounding box is electronically tinted or otherwise rendered opaque, and the mapped enhanced view is projected on the (adjusted) opaque portion of the windshield. In this way, the operator may customize the display of the enhanced view on the windshield.

Returning to 512, if at 512 the request to switch off the enhanced view is received from the operator, method 500 proceeds to 518. At 518, method 500 includes terminating rendering the portion of the windshield on which the enhanced view is displayed opaque, and method 500 proceeds to 520. At 520, method 500 includes terminating the display of the enhanced view on the portion of the windshield, and method 500 ends. By terminating the opacity (e.g., the electronic tinting) of the portion of the windshield prior to terminating the display of the enhanced view on the portion of the windshield, a situation may be avoided where an opaque portion of the window is visible to the operator without the enhanced view projected upon it.

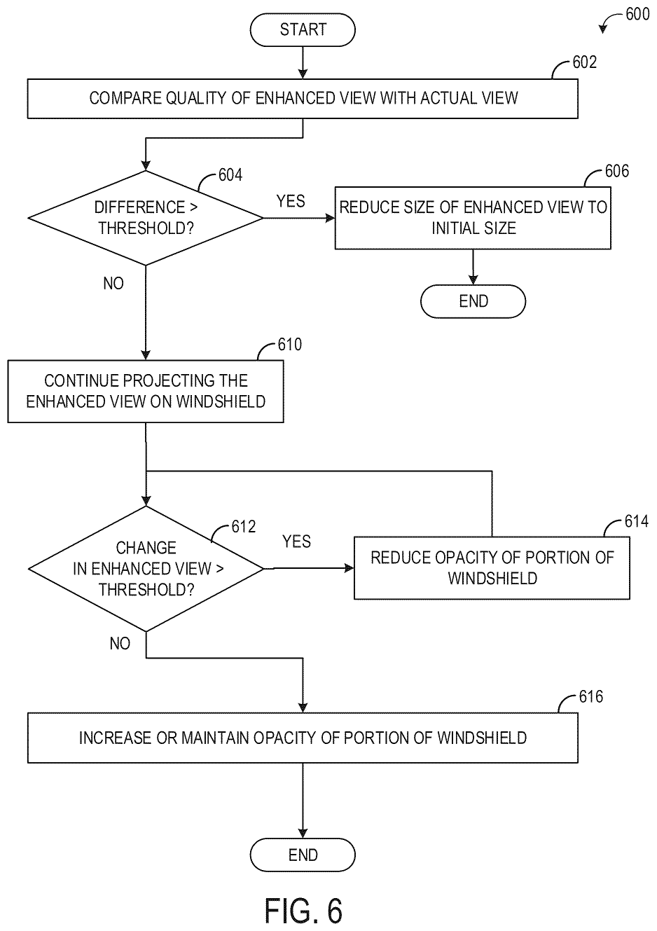

In some circumstances, a visibility of environment in front of the vehicle may become so obstructed that an enhanced view being displayed on the windshield may not offer increased visibility over an actual view of the operator through the windshield. In such circumstances the enhanced view may be terminated. The termination of the enhanced view due to changing environmental conditions is described in reference to FIG. 6.

Referring now to FIG. 6, an exemplary method 600 is shown for terminating the enhanced view in response to a change in an environment of the vehicle, and/or a change in a quality of the enhanced view for a different reason. Method 600 may be performed during the execution of method 500 of FIG. 5, when the enhanced view described above is being displayed on the windshield of the vehicle.

Method 600 starts at 602, where method 600 includes comparing a quality of the enhanced view of the front of the vehicle, meaning the enhanced images generated as a result of applying the one or more AI algorithms of method 500, with an actual view of the camera acquiring the video feed, meaning the images of the video feed prior to applying the one or more AI algorithms. The quality may be compared as described in step 410 of method 400 above.

At 604, if the quality of the enhanced view is greater than a quality of the actual view by a predefined threshold amount, then method 600 proceeds to 606. At 606, method 600 includes reducing the size of the enhanced view to the initial size, based on the first bounding box. In other words, if the visibility of the environment in front of the vehicle in the enhanced view is not greater than the visibility of the environment in the unaltered images captured by the camera, the enhanced view may not be preferred by the operator. In such cases, the enhanced view may be displayed at the initial size and position, which may occupy a small proportion of the total area of the windshield. When the size of the enhanced view is reduced, the external environment in front of the vehicle may be visible to the operator through the windshield, with the exception of the portion on which the enhanced view is projected, as described in method 400. The operator may then be able to visually compare the enhanced view with the operator's actual view through the windshield. If the operator prefers the enhanced view, the operator may expand the enhanced view as described in method 500. If the operator prefers the actual view, the operator may terminate the display of the enhanced view on the windshield. In this way, the operator decides what is most appropriate, and may take advantage of the enhanced view when suitable, or dismiss the enhanced view when not suitable.

If at 604 the quality of the enhanced view is greater than the quality of the actual view by the threshold amount, method 600 proceeds to 610. At 610, method 600 includes continuing to project the enhanced view on the windshield (e.g., without adjusting a size of the enhanced view).

At 612, method 600 includes determining whether a change is detected in the enhanced view that is greater than a threshold change. In some circumstances, the quality of the enhanced view may decrease as a result of factors not associated with the adverse weather. For example, the vehicle may enter a tunnel, or a parking garage, and lighting conditions in the environment of the vehicle may change rapidly. In such situations, the quality of images acquired via the camera may decrease during an adjustment period, for example, during which a lens and/or other settings of the camera may be adjusted, and/or during which a different AI algorithm is applied. As another example, a bright light of an oncoming vehicle may cause a readjustment of the camera, which may momentarily reduce a quality of the acquired images. This may cause the enhanced view to suddenly brighten, or suddenly darken, before the camera adjusts and compensates for the changing lighting conditions. When this occurs, for a brief duration, the enhanced view may have a poorer visibility than the actual view of the operator through the windshield. In such cases, it may be safer and more comfortable for the operator to rely on their actual view, and not the enhanced view.

The change in the enhanced view may be detected by the view enhancement subsystem. In one example, an algorithm may store a sequence of images acquired by the camera over a predefined duration (e.g., a few seconds) in a buffer. A running average pixel intensity of the images over the duration may be calculated and compared with a pixel intensity of each new image acquired by the camera, individually or collectively. If a difference between the pixel intensity of an image with an average pixel intensity of an immediately preceding sequence of images is greater than a threshold intensity, it may be inferred that the enhanced view may be affected by a change in lighting conditions, whereby method 600 proceeds to 614.

At 614, method 600 includes reducing an opacity of the portion of the windshield on which the enhanced view is projected. For example, the electronic tinting may be reduced by 50%, or 75%, or a different percent. When the opacity of the portion is reduced, the portion may become partially transparent, allowing the operator to see the external environment in front of the vehicle through the enhanced view projected on the windshield. By making the portion partially transparent, a sudden decrease in the quality of the enhanced view may be less disruptive to the operator, without terminating the enhanced view. Because the operator's eyes may be faster at adjusting to the sudden change in conditions than the lens of the camera, allowing the operator to see the external environment through the enhanced view may increase the safety and comfort of the operator during the transition.

After the opacity of the portion is reduced, method 600 proceeds back to 612. When the enhanced view stabilizes, and no sudden changes in the pixel intensity of the images acquired by the camera are detected at 612, method 600 proceeds to 616. At 616, method 600 includes increasing the opacity of the portion of the windshield, or maintaining the opacity, in the case that no change in the enhanced view is detected at 612. For example, the electronic tinting may be increased to a degree at which the portion is opaque, and the enhanced view may be seen on the portion of the windshield.

In other embodiments, in response to the change in the enhanced view being greater than the threshold amount at 612, method 600 may additionally or alternatively include reducing the size of the enhanced view to the initial size, as described at step 606.

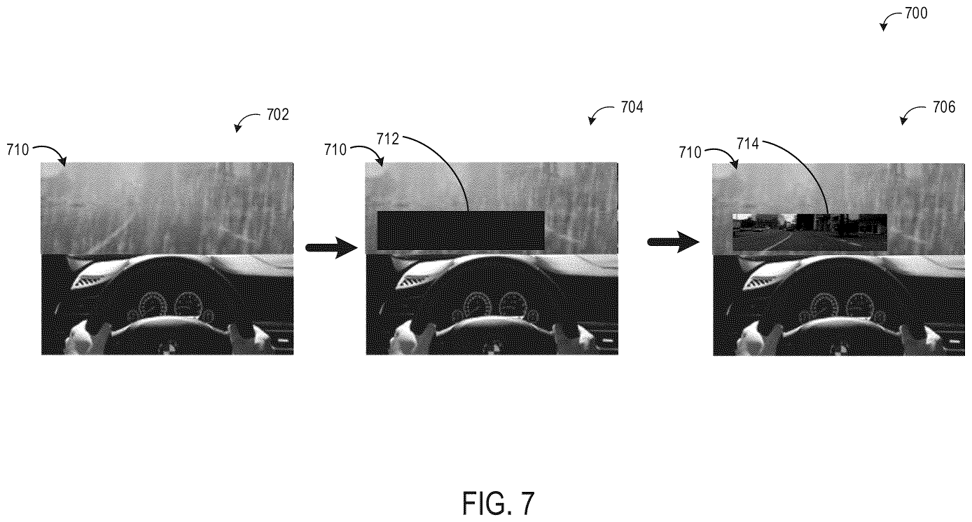

FIG. 7 shows a first set of example views 700 of a windshield 710 of a vehicle during adverse weather (e.g., heavy rain), where an operator of the vehicle requests the enhanced view of the front view of the vehicle to be projected on windshield 710 via an AR projector (e.g., AR projector 306). A first image 702 shows the operator driving in the heavy rain, where the heavy rain is visible through (transparent) windshield 710. A second image 704 shows a portion 712 of windshield 710 electronically tinted to be opaque, where the front view of the vehicle is not visible through the opaque portion 712 of windshield 710. Second image 704 may represent a state of windshield 710 after step 506 of method 500 is performed.

A third image 706 shows an enhanced view 714 generated from images acquired via a camera on a front of the vehicle, which is projected onto opaque portion 712 by the AR projector. The enhanced view 714 does not include the heavy rain. That is, rain drops and rain streaks on the camera lens caused by the heavy rain have been removed by one or more AI algorithms (e.g., AI algorithms 213) applied by the view enhancement subsystem. An external front environment of the vehicle including the road may be more clearly visible to the operator in enhanced view 714 than through the transparent portion of windshield 710. Third image 706 may be taken after performing step 508 of method 500.

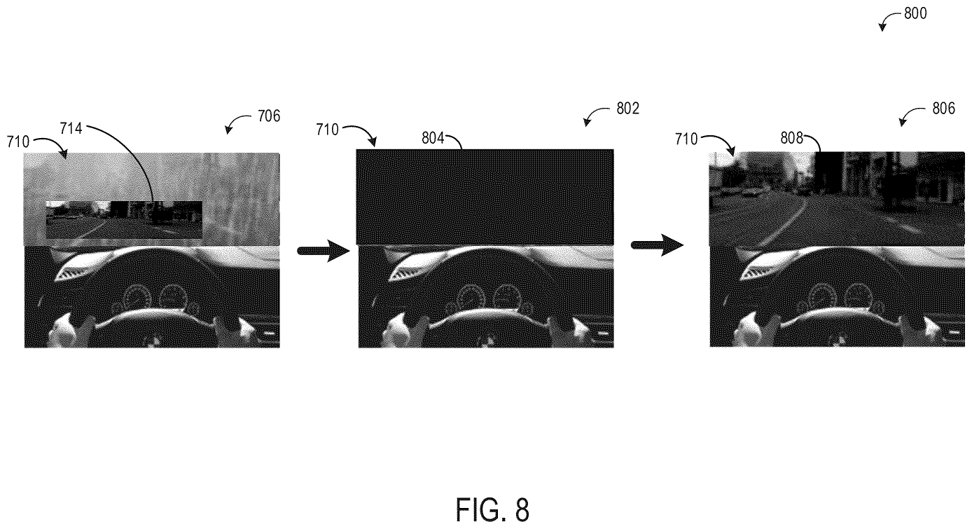

In third image 706, opaque portion 712 and enhanced view 714 have a first size, which occupies a small percentage of a total area of the windshield. The operator may assess a quality of enhanced view 714, while still being able to view the front of the vehicle through windshield 710. If the environment in front of the vehicle is more clearly visible in enhanced view 714 than through windshield 710, the operator may expand enhanced view 714 to occupy a greater area of windshield 710, as shown in FIG. 8.

Referring now to FIG. 8, a second set of example views 800 of the windshield of FIG. 7 during the heavy rain are shown, including third image 706, where the operator of the vehicle is viewing enhanced view 714 projected on opaque portion 712 of windshield 710 via the AR projector. The operator may wish to expand and enlarge enhanced view 714 on windshield 710, which shows a clearer view of the front environment of the vehicle than a view of the operator through transparent portions of windshield 710. The operator may issue a voice command to expand enhanced view 714. When the operator issues the command, the view enhancement subsystem may retrieve a bounding box for an expanded enhanced view 714 from a memory of the view enhancement subsystem, which may be bigger than an initial bounding box of enhanced view 714. The view enhancement subsystem may map the bounding box onto the windshield, and electronically tint a second, larger portion 804 of windshield 710 (e.g., larger than opaque portion 712 of FIG. 7) corresponding to the bounding box, as shown in a fourth image 802. After second portion 804 has been electronically tinted, the view enhancement subsystem may map the images comprising the enhanced view to second portion 804, and project the mapped images onto second portion 804 to generate a second enhanced view 808, as shown in a fifth image 806. In fifth image 806, second enhanced view 808 occupies a total area of windshield 710. In other examples, second enhanced view 808 may occupy a different amount of the total area of windshield 710.

Thus, systems and methods are disclosed for increasing a visibility of a front environment of a vehicle for an operator of the vehicle by projecting video images of the front environment onto a windshield of the vehicle, where the projected video images are processed by one or more AI algorithms to increase the visibility of the front environment. For example, the one or more AI algorithms may increase an amount of light in the projected video images, and/or reduce or remove elements of the images that obstruct a view of the operator including rain, snow, fog, dust, smoke, etc. In particular, the systems and methods facilitate resizing and repositioning of the projected video images based on commands provided by the operator. Projecting the video images on the windshield may also include electronically tinting a selected portion of the windshield, and processing the video images to map the video images to the selected portion, which may not be centered in front of an AR projector or perpendicular to the AR projector, to ensure an accurate representation of the environment in front of the vehicle on the windshield. Methods are also provided to reduce a size of the processed video images, or reduce the electronic tinting of the windshield to allow the operator to see through the video images, in the event of unexpected changes in the quality of the processed video images. The technical effect of projecting images of the front of the vehicle that have been processed to remove aspects of weather from the images on a windshield of the vehicle is that a safety and comfort of the operator may be increased. The technical effect of the disclosed methods for sizing, placing, and controlling a translucence of the enhanced view of the front of the vehicle projected on the windshield is that the operator may benefit from an increased visibility of the enhanced view without sacrificing an actual view of the front of the vehicle through the windshield.

The disclosure also provides support for a system for a vehicle, the system comprising: an augmented reality (aR) projector, and an in-vehicle computing system including a memory storing instructions executable to: when the vehicle is being operated under low-visibility conditions: capture video images of a front view of the vehicle in real time, via a camera of the vehicle, process the captured video images to create an enhanced view of the front view, using one or more artificial intelligence (aI) algorithms, render a portion of a windshield of the vehicle opaque, and project the enhanced view on the opaque portion of the windshield of the vehicle using the aR projector. In a first example of the system, the low-visibility conditions include visual weather elements that obscure the front view, the visual weather elements including one or more of rain, snow, fog, dust, and smoke. In a second example of the system, optionally including the first example, the windshield is constructed with glass having liquid crystals embedded therein, the liquid crystals electrically connected to a battery of the vehicle, and rendering the portion of the windshield opaque further comprises applying a voltage to the liquid crystals to electronically tint the portion of the windshield. In a third example of the system, optionally including one or both of the first and second examples, rendering the portion of the windshield opaque further comprises: determining a first bounding box of the enhanced view, the bounding box defined by coordinates on a virtual plane perpendicular to a direction of projection of the AR projector, mapping the first bounding box to a second bounding box of a second plane defined by a surface of the windshield, based on a predefined geometric model, rendering an area of the windshield within the second bounding box opaque. In a fourth example of the system, optionally including one or more or each of the first through third examples, the first bounding box is retrieved from a configuration file or a lookup table stored in the memory. In a fifth example of the system, optionally including one or more or each of the first through fourth examples, at a first instance of rendering the portion of the windshield opaque, the area of the windshield within the second bounding box occupies less than 20% of a total area of the windshield. In a sixth example of the system, optionally including one or more or each of the first through fifth examples, projecting the enhanced view on the opaque portion of the windshield of the vehicle using the AR projector further comprises mapping the enhanced view to the second bounding box in accordance with a predefined geometric model. In a seventh example of the system, optionally including one or more or each of the first through sixth examples, one of a size of the first bounding box and a position of the first bounding box is determined based on a command issued by an operator of the vehicle. In a eighth example of the system, optionally including one or more or each of the first through seventh examples, the command is a voice command received at a microphone in a cabin of the vehicle. In a ninth example of the system, optionally including one or more or each of the first through eighth examples, further instructions are stored in the memory that when executed, cause the in-vehicle computing system to reduce a size of the enhanced view projected on the windshield in response to a difference between a first quality of the captured video images and a second quality of the processed video images being greater than a threshold difference. In a tenth example of the system, optionally including one or more or each of the first through ninth examples, further instructions are stored in the memory that when executed, cause the in-vehicle computing system to reduce an opacity of the enhanced view projected on the windshield in response to a difference between a pixel intensity of a processed video image and an average pixel intensity of a sequence of processed video images immediately preceding the processed video image being greater than a threshold difference.

The disclosure also provides support for a method for a controller of a vehicle, the method comprising: while operating the vehicle in low-visibility conditions: capturing video images of a view of an environment in front of the vehicle in real time, via a camera of the vehicle, processing the captured video images using one or more artificial intelligence (aI) algorithms to create an enhanced view of environment in front of the vehicle, and displaying the enhanced view on a portion of a windshield of the vehicle, wherein the low-visibility conditions are due to a presence of visual weather elements including at least one of snow, fog, rain, dust, and smoke, and the enhanced view includes the view of the environment in front of the vehicle with the visual weather elements reduced or removed, or the low-visibility conditions are due to a low level of lighting of the video images, and the enhanced view includes the view of the environment in front of the vehicle with increased lighting. In a first example of the method, displaying the enhanced view on the portion of the windshield of the vehicle further comprises rendering the portion of a windshield of the vehicle opaque, and projecting the enhanced view on the opaque portion via a projector of the vehicle. In a second example of the method, optionally including the first example, the windshield is constructed with one of: glass having liquid crystals embedded therein, the liquid crystals electrically connected to a battery of the vehicle, wherein rendering the portion of the windshield opaque further comprises applying a voltage to the liquid crystals to electronically tint the portion of the windshield, and glass having an electroluminescent film in or on the glass, where the enhanced view is displayed on the windshield via the electroluminescent film. In a third example of the method, optionally including one or both of the first and second examples, displaying the enhanced view on the windshield further comprises: retrieving a first bounding box of the enhanced view from a lookup table stored in a memory of the vehicle, the bounding box defined by coordinates on a virtual plane perpendicular to a direction of projection of the projector, mapping the first bounding box to a second bounding box of a second plane defined by a surface of the windshield, based on a predefined geometric model, displaying the enhanced view on the windshield within the second bounding box. In a fourth example of the method, optionally including one or more or each of the first through third examples,: at a first instance of displaying the enhanced view on the portion of the windshield, an area of the windshield within the second bounding box occupies less than 20% of a total area of the windshield, and in response to a command issued by an operator of the vehicle: retrieving a third bounding box from the memory, the third bounding box having a size greater than the first bounding box, mapping the third bounding box to a fourth bounding box of the second plane defined by the surface of the windshield, based on the predefined geometric model, and displaying the enhanced view on the windshield within the fourth bounding box. In a fifth example of the method, optionally including one or more or each of the first through fourth examples, the method further comprises: reducing a size of the enhanced view displayed on the windshield in response to a difference between a first quality of the captured video images and a second quality of the processed video images being greater than a threshold difference. In a sixth example of the method, optionally including one or more or each of the first through fifth examples, the method further comprises: reducing an opacity of the enhanced view displayed on the windshield in response to a difference between a pixel intensity of a processed video image and an average pixel intensity of a sequence of processed video images immediately preceding the processed video image being greater than a threshold difference.

The disclosure also provides support for a method for controlling a display of video images projected on a windshield of a vehicle, the method comprising: determining a bounding box for the projected images on the windshield, the bounding box defining a portion of the windshield, applying a voltage to liquid crystals embedded in the portion of the windshield to electronically tint the portion of the windshield, mapping the images to a plane defined by a surface of the portion of the windshield, based on a predefined geometric model, projecting the images on the electronically tinted portion of the windshield via a projector, in response to receiving a first voice command from an operator of the vehicle captured at a microphone of the vehicle, adjusting a position of the bounding box on the windshield, and in response to receiving a second voice command from the operator captured at the microphone of the vehicle, adjusting a size of the bounding box on the windshield. In a first example of the method, the projected images are video images captured in real time by a front end camera of the vehicle and processed by one or more artificial intelligence (AI) algorithms to increase a visibility of elements of an environment in front of the vehicle in the video images.

The description of embodiments has been presented for purposes of illustration and description. Suitable modifications and variations to the embodiments may be performed in light of the above description or may be acquired from practicing the methods. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, etc. The described methods and associated actions may also be performed in various orders in addition to the order described in this application, in parallel, and/or simultaneously. Further, the described methods may be repeatedly performed. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A system for a vehicle, the system comprising:
an augmented reality (AR) projector; and
an in-vehicle computing system including a memory storing instructions executable to:
when the vehicle is being operated under low-visibility conditions:
capture video images of a front view of the vehicle in real time, via a camera of the vehicle;
process the captured video images to create an enhanced view of the front view, using one or more artificial intelligence (AI) algorithms;
render a portion of a windshield of the vehicle opaque; and
project the enhanced view on the opaque portion of the windshield of the vehicle using the AR projector.

2. The system of claim 1, wherein the low-visibility conditions include visual weather elements that obscure the front view, the visual weather elements including one or more of rain, snow, fog, dust, and smoke.

3. The system of claim 1, wherein the windshield is constructed with glass having liquid crystals embedded therein, the liquid crystals electrically connected to a battery of the vehicle, and rendering the portion of the windshield opaque further comprises applying a voltage to the liquid crystals to electronically tint the portion of the windshield.

4. The system of claim 1, wherein rendering the portion of the windshield opaque further comprises:
determining a first bounding box of the enhanced view, the bounding box defined by coordinates on a virtual plane perpendicular to a direction of projection of the AR projector;
mapping the first bounding box to a second bounding box of a second plane defined by a surface of the windshield, based on a predefined geometric model;
rendering an area of the windshield within the second bounding box opaque.

5. The system of claim 4, wherein the first bounding box is retrieved from a configuration file or a lookup table stored in the memory.

6. The system of claim 4, wherein at a first instance of rendering the portion of the windshield opaque, the area of the windshield within the second bounding box occupies less than 20% of a total area of the windshield.

7. The system of claim 4, wherein projecting the enhanced view on the opaque portion of the windshield of the vehicle using the AR projector further comprises mapping the enhanced view to the second bounding box in accordance with a predefined geometric model.

8. The system of claim 4, wherein one of a size of the first bounding box and a position of the first bounding box is determined based on a command issued by an operator of the vehicle.

9. The system of claim 8, wherein the command is a voice command received at a microphone in a cabin of the vehicle.

10. The system of claim 1, wherein further instructions are stored in the memory that when executed, cause the in-vehicle computing system to reduce a size of the enhanced view projected on the windshield in response to a difference between a first quality of the captured video images and a second quality of the processed video images being greater than a threshold difference.

11. The system of claim 1, wherein further instructions are stored in the memory that when executed, cause the in-vehicle computing system to reduce an opacity of the enhanced view projected on the windshield in response to a difference between a pixel intensity of a processed video image and an average pixel intensity of a sequence of processed video images immediately preceding the processed video image being greater than a threshold difference.

12. A method for a controller of a vehicle, the method comprising:
while operating the vehicle in low-visibility conditions:
capturing video images of a view of an environment in front of the vehicle in real time, via a camera of the vehicle;
processing the captured video images using one or more artificial intelligence (AI) algorithms to create an enhanced view of environment in front of the vehicle; and
displaying the enhanced view on a portion of a windshield of the vehicle;
wherein the low-visibility conditions are due to a presence of visual weather elements including at least one of snow, fog, rain, dust, and smoke, and the enhanced view includes the view of the environment in front of the vehicle with the visual weather elements reduced or removed, or the low-visibility conditions are due to a low level of lighting of the video images, and the enhanced view includes the view of the environment in front of the vehicle with increased lighting.

13. The method of claim 12, wherein displaying the enhanced view on the portion of the windshield of the vehicle further comprises rendering the portion of a windshield of the vehicle opaque, and projecting the enhanced view on the opaque portion via a projector of the vehicle.

14. The method of claim 13, wherein the windshield is constructed with one of:
glass having liquid crystals embedded therein, the liquid crystals electrically connected to a battery of the vehicle, wherein rendering the portion of the windshield opaque further comprises applying a voltage to the liquid crystals to electronically tint the portion of the windshield; and
glass having an electroluminescent film in or on the glass, where the enhanced view is displayed on the windshield via the electroluminescent film.

15. The method of claim 13, wherein displaying the enhanced view on the windshield further comprises:
retrieving a first bounding box of the enhanced view from a lookup table stored in a memory of the vehicle, the bounding box defined by coordinates on a virtual plane perpendicular to a direction of projection of the projector;
mapping the first bounding box to a second bounding box of a second plane defined by a surface of the windshield, based on a predefined geometric model;
displaying the enhanced view on the windshield within the second bounding box.

16. The method of claim 15, wherein:
at a first instance of displaying the enhanced view on the portion of the windshield, an area of the windshield within the second bounding box occupies less than 20% of a total area of the windshield; and
in response to a command issued by an operator of the vehicle:
retrieving a third bounding box from the memory, the third bounding box having a size greater than the first bounding box;
mapping the third bounding box to a fourth bounding box of the second plane defined by the surface of the windshield, based on the predefined geometric model; and
displaying the enhanced view on the windshield within the fourth bounding box.

17. The method of claim 12, further comprising reducing a size of the enhanced view displayed on the windshield in response to a difference between a first quality of the captured video images and a second quality of the processed video images being greater than a threshold difference.

18. The method of claim 12, further comprising reducing an opacity of the enhanced view displayed on the windshield in response to a difference between a pixel intensity of a processed video image and an average pixel intensity of a sequence of processed video images immediately preceding the processed video image being greater than a threshold difference.

19. A method for controlling a display of video images projected on a windshield of a vehicle, the method comprising:
determining a bounding box for the projected images on the windshield, the bounding box defining a portion of the windshield;
applying a voltage to liquid crystals embedded in the portion of the windshield to electronically tint the portion of the windshield;
mapping the images to a plane defined by a surface of the portion of the windshield, based on a predefined geometric model;
projecting the images on the electronically tinted portion of the windshield via a projector;
in response to receiving a first voice command from an operator of the vehicle captured at a microphone of the vehicle, adjusting a position of the bounding box on the windshield; and
in response to receiving a second voice command from the operator captured at the microphone of the vehicle, adjusting a size of the bounding box on the windshield.

20. The method of claim 19, wherein the projected images are video images captured in real time by a front end camera of the vehicle and processed by one or more artificial intelligence (AI) algorithms to increase a visibility of elements of an environment in front of the vehicle in the video images.
